(19) United States
(12) Patent Application Publication
(10) Pub. No.: US 2013/0248496 A1
(43) Pub. Date: Sep. 26, 2013

(54) PRECISION RIBBON RESISTANCE WELDING SYSTEM

(71) Applicants: Reza Imani, Moorpark, CA (US); Asghar Dadashian, Porter Ranch, CA (US); Dro Darbidian, La Canada-Flintridge, CA (US); Hamid Habibi, Calabasas, CA (US)

(72) Inventors: Reza Imani, Moorpark, CA (US); Asghar Dadashian, Porter Ranch, CA (US); Dro Darbidian, La Canada-Flintridge, CA (US); Hamid Habibi, Calabasas, CA (US)

(73) Assignee: PACESETTER, INC., Sylmar, CA (US)

(21) Appl. No.: 13/429,033

(22) Filed: Mar. 23, 2012

(51) Int. Cl. B23K 11/00

(52) U.S. Cl. CPC B23K 11/00
USPC 219/78.01

(57) ABSTRACT

Disclosed herein is a resistance welding system for welding a ribbon to a bond site of a bond surface. The system includes a welding header, a bond header, a ribbon dispenser, a cutter, and a support surface. The welding header includes a resistance welding tip. The bond header includes a bond foot displaceable relative to the bond surface. The bond foot includes a welding aperture. The ribbon dispenser feeds the ribbon to the bond foot. The support surface is configured to support the bond surface. The bond foot is configured to press the ribbon against the bond site of the bond surface, which is thereby forced against the support surface. With the ribbon so pressed against the bond site, the system is configured to cause the welding tip to enter the welding aperture to resistance weld the ribbon to the bond site of the bond surface.

### FIELD OF THE INVENTION

Aspects of the present invention relate to systems and methods for manufacturing. More specifically, the present invention relates to systems and methods for resistance welding electrical connections between electrical components of implantable medical pulse generators.

### BACKGROUND OF THE INVENTION

Implantable medical pulse generators such as, for example, pacemakers and implantable cardioverter defibrillators (ICDs), contain various electrical components that are electrically connected together. Currently, a variety of connection methods are employed to electrically connect together the electrical components of a first type of pulse generator, while a different variety of connection methods may be employed for another type of pulse generator. Examples of connection methods include soldering, wire bonding, connectors, etc. The electrical connections between the various electrical components must be robust and capable of being achieved efficiently and economically.

There is a need in the art for systems and methods of achieving electrical connections within an implantable medical pulse generator that are more robust and economical. Further, there is a need in the art for systems and methods of achieving electrical connections within an implantable medical pulse generator, wherein the systems and methods are more commonly applicable across a wider variety of pulse generators and electrical components within pulse generators. In other words, there is a need in the art for a method of achieving electrical connections within an implantable medical pulse generator that will work for all types of pulse generators and all types of electrical connections within the pulse generators.

### BRIEF SUMMARY OF THE INVENTION

Disclosed herein is a resistance welding system for welding a ribbon to a bond site of a bond surface. In one embodiment, the system includes a welding header, a bond header, a ribbon dispenser, a cutter, and a support surface. The welding header includes a resistance welding tip. The bond header includes a bond foot displaceable relative to the bond surface. The bond foot includes a welding aperture. The ribbon dispenser feeds the ribbon to the bond foot. The cutter is near the bond foot. The support surface is configured to support the bond surface. The bond foot is configured to press the ribbon against the bond site of the bond surface, which is thereby forced against the support surface. With the ribbon so pressed against the bond site, the system is configured to cause the welding tip to enter the welding aperture to resistance weld the ribbon to the bond site of the bond surface. The system also configured to then move the bond foot to a location adjacent the bond site and cause the cutter to sever the ribbon at a location between the bond foot and the bond site.

Also disclosed herein is a method of connecting electrical components of an implantable medical pulse generator during the course of manufacturing the implantable medical pulse generator. In one embodiment, the method includes: a) supporting an electrical component on a support surface of a resistance welding system; b) feeding a ribbon between a bond foot of the resistance welding system and a bond site of a bond surface of the electrical component; c) causing the bond foot to press the ribbon against the bond site of the bond surface, thereby forcing the electrical component against the support surface; d) with the bond foot pressed against the ribbon as recited in step c), causing a resistance welding tip to enter a welding aperture of the bond foot; e) causing the resistance welding tip to resistance weld the ribbon to the bond site of the bond surface within the confines of the aperture; f) causing the bond foot to displace to a location adjacent the a weld resulting from step e); and g) using a cutter to sever the ribbon between the weld and the location adjacent the weld.

While multiple embodiments are disclosed, still other embodiments of the present disclosure will become apparent to those skilled in the art from the following detailed description, which shows and describes illustrative embodiments of the disclosure. As will be realized, the invention is capable of modifications in various aspects, all without departing from the spirit and scope of the present disclosure. Accordingly, the drawings and detailed description are to be regarded as illustrative in nature and not restrictive.

### BRIEF DESCRIPTION OF THE DRAWINGS

FIG. 1 is a diagram illustrating an embodiment of a precision ribbon resistance welding system.

FIG. 2 is an isometric view of the bond header and welding header positioned nearby, wherein the bond header is configured to allow the welding header to enter the bond header laterally.

FIG. 2A is an isometric view of the bond header and welding header positioned nearby, wherein the bond header is configured to allow the welding header to enter the bond header vertically.

FIG. 3 is an enlarged isometric view of a first embodiment of the bond foot with the welding header positioned nearby, wherein the bond header is configured to allow the welding header to enter the bond header laterally.

FIG. 4 is a bottom plan view of the bond foot of FIG. 3.

FIGS. 5 and 6 are the same respective views as FIGS. 3 and 4, except of another embodiment.

FIG. 7 is an enlarged isometric view of another embodiment of the bond foot with the welding header positioned nearby, wherein the bond header is configured to allow the welding header to enter the bond header vertically.

FIGS. 8 and 9 are, respectively, a side elevation view and a side elevation cross sectional view of the embodiment of the bond foot depicted in FIGS. 3 and 4.

FIG. 10 is the same view as FIG. 8, except the ribbon has been welded to the first bond site and the bond header is displacing to a second bond site.

FIG. 11 is the same view as FIG. 8, except the bond header and welding tip are at the second bond site and welding the ribbon to the second bond site.

FIG. 12 is the same view as FIG. 8, except the bond header is moving away from the completed welding of the ribbon to the second bond site.

FIG. 13 is a view similar to that of FIG. 12, except the bond header has moved to a location adjacent the second bond site and the ribbon is being severed via a cutter.

### DETAILED DESCRIPTION

Implementations of the present disclosure involve a precision ribbon resistance welding system 10 and methods of resistance welding with such a system. The system 10 is useful in making precise electrical connection between electrical circuits and components of electronic devices such as implantable pulse generators such as, for example, pacemakers and implantable cardioverter defibrillators (ICDs).

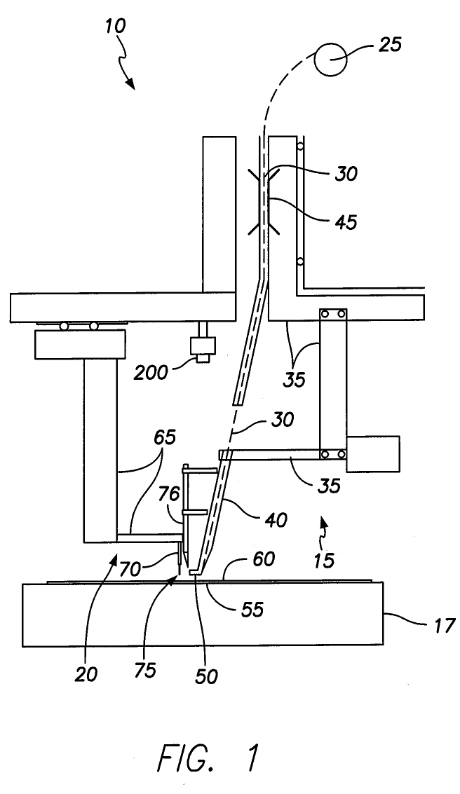

FIG. 1 is a diagram illustrating an embodiment of a precision ribbon resistance welding system 10 disclosed herein. As shown in FIG. 1, the system 10 includes a ribbon assembly 15, a support surface 17, and a welding assembly 20. The two assemblies 15, 20 may be supported of off separate support structures or may share the same support structure but be independently moveable relative to each other. Specifically, in one embodiment, the resistance welding assembly 20 is stationary or fixed, the support surface 17 and ribbon assembly 15 are moveable relative to each other, and the support surface 17 and ribbon assembly 15 are moveable as a unit relative to the welding assembly 20.

The ribbon assembly 15 may include a spool 25 on which a ribbon 30 is rolled off of when dispensed from the spool 25 through the ribbon assembly. The ribbon assembly 15 also includes a bond arm 35 that supports a bond header 40 and a ribbon clamp 45. The ribbon 30 extends from the spool 25 down through the ribbon clamp 45 and along or through the bond header 40 to a bond foot 50 at a bottom end of the bond header 40. The bond foot 50 is positioned over a bond site 55 of a bond surface 60, which may be a location on a circuit board, ICD hybrid, or other electrical circuit element that is to be electrically connected to another electrical circuit element via the system 10. The ribbon assembly 15 is configured so as to allow the bond foot 50 to be moved in a controlled and precise manner from bond site 55 to bond site as electrical circuit elements are electrically coupled to each other via welding of a first end of a segment of ribbon 30 to a first bond site of a first electrical circuit element and welding of a second end of a segment of ribbon 30 to a second bond site of a second electrical circuit element.

The support surface 17 may be in the form of a platform or table on which bond surface 60 may be supported and secured. Thus, if the support surface 17 moves, the bond surface 60 will likewise move with the support surface 17.

The welding assembly 20 may include a welding arm 65 that supports a welding header 70. In one embodiment, the welding assembly 20 or at least the welding arm 65 is configured so as to allow the welding header 70 and, more specifically, a resistance welding tip 75 of the welding header 70 to move into and out of the bond foot 50, as discussed in detail below. Because in one embodiment the resistance welding tip 75 is fixed and non-displaceable, as discussed in detail below, the movement of the welding tip 75 into and out of the bond foot 50 is accomplished via movement of the bond foot 50 and support surface 17 as a unit relative to the welding tip 75.

In another embodiment, as discussed below, the resistance welding tip 75 is configured to move with the bond foot 50 laterally as a unit. The welding tip 75 displaces vertically into and out of the bond foot 50.

As illustrated in FIG. 1, a cutter 76 is supported off of the bond header 40. The cutter 76 has a cutting edge 77 that moves vertically to sever the ribbon 30 as discussed in detail below.

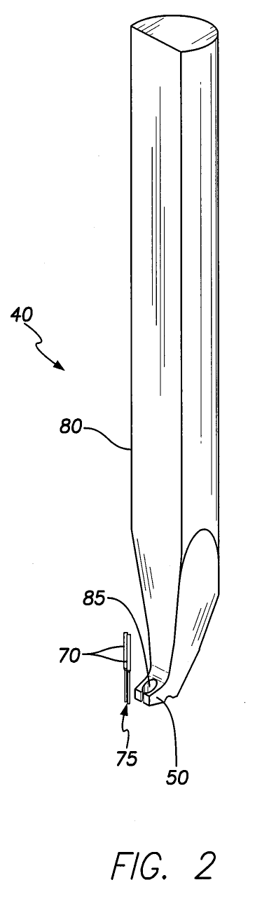

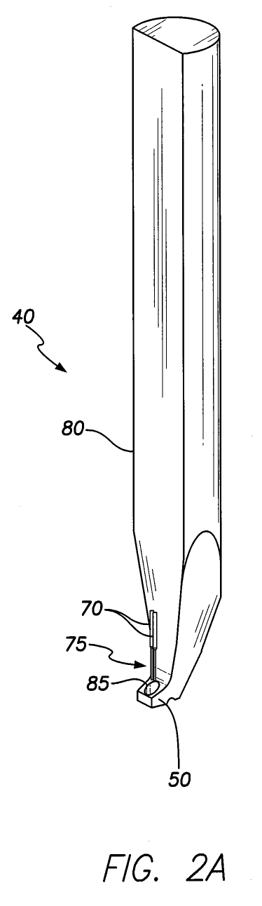

As shown in FIG. 2, which is an isometric view of the bond header 40 and welding header 70 positioned nearby, the bond header includes an elongated body 80 that extends down to the bond foot 50. A welding aperture 85 is defined in the bond foot, and the welding tip 75 of the welding header 70 is positioned to the side of the bond foot 50 so as to be able to enter the welding aperture 85 via movement of the bond foot 50 and support surface 17 as a unit relative to the welding tip 75. Alternatively, as illustrated in FIG. 2A, the welding header 70 may be centered over the welding aperture 85 and configured to move with the welding header 70 as a unit such that when the welding header is positioned at a location where a weld is to be made, the welding header 70 may simply displace vertically to enter the welding aperture 85 to create the weld.

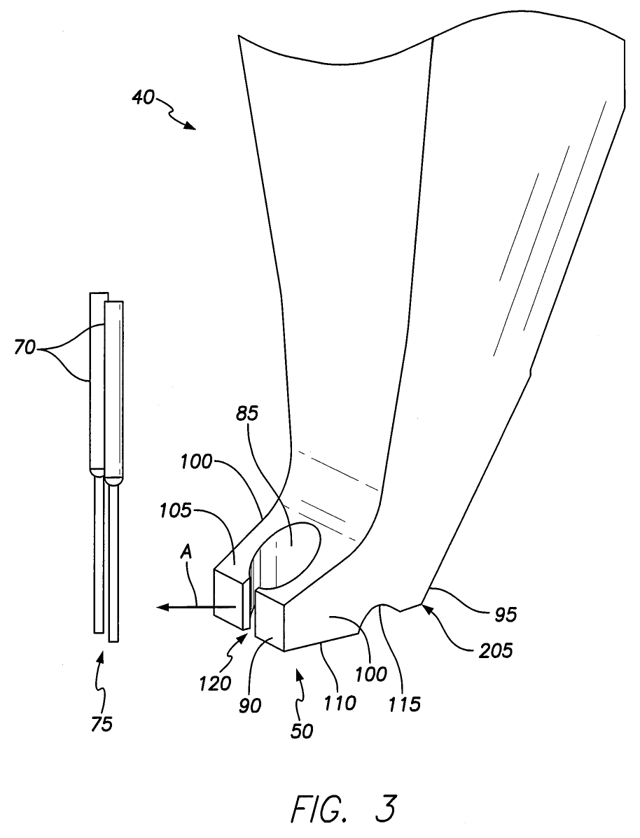

As illustrated in FIG. 3, which is an enlarged isometric view of a first embodiment of the bond foot 50 with the welding header 70 positioned nearby, the bond foot includes a front or toe 90, a back or heal 95 opposite the toe 90, and lateral sides 100 extending between the heal 95 and toe 90. The bond foot 50 also includes a top surface 105, a bottom surface 110 with an arch 115 defined in the bottom surface near the heal 95, and a welding aperture 85 that extends vertically through the bond foot 50 from the top surface 105 to the bottom surface 110. The welding aperture 85 is generally centered in the top surface 105 and substantially circular or, in other embodiments, of other shapes, such as, for example, square, rectangular, oval, etc. A welding access slot 120 extends through the toe 90 to join the welding aperture 85. The slot 120 is sized such that the resistance welding tip 75, which has dual electrodes, may pass into the welding aperture 85 to assume a position within the welding aperture 85 to perform a weld as described below.

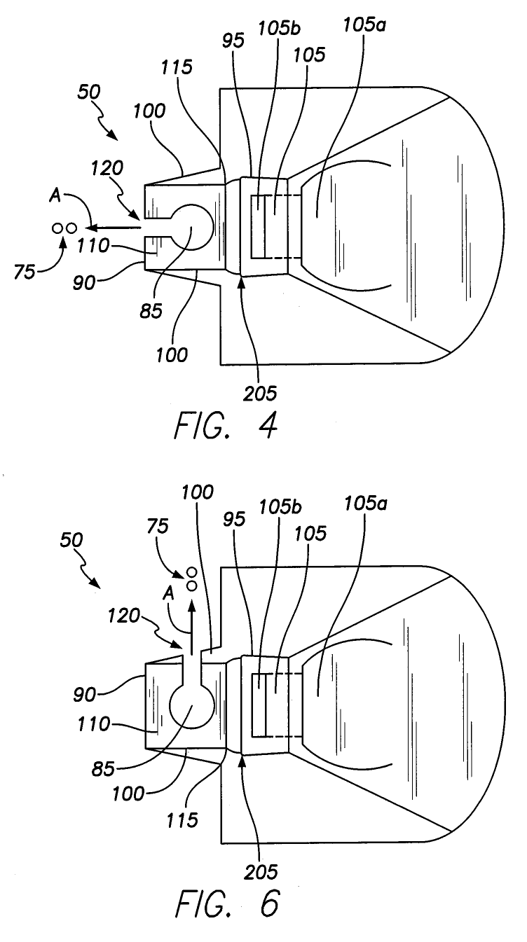

As depicted in FIG. 4, which is a bottom plan view of the bond foot 50 of FIG. 3, the welding aperture 85 is generally centered in the bottom surface 110 and substantially circular or, in other embodiments, of other shapes, such as, for example, square, rectangular, oval, etc. A ribbon threading slot 105 is supported on the bond foot 50 above the heal 95. The ribbon threading slot 105 has a threading slot entrance 105a into which the ribbon 30 (see FIG. 1) can enter from the back of the bond head 100. The threading slot 105 also has a threading slot exit 105b from which the ribbon 30 may exit while the ribbon is being spooled out in connection with loop formation, described below.

As indicated by arrow A in FIGS. 3 and 4, the bond header 40 may displace generally, exclusively, horizontally so as to cause the resistance welding tip 75 to pass through the wall of the toe 90 via the welding access slot 120 into the welding aperture 85. In one embodiment, the welding aperture 85 has a diameter of between approximately 0.035″ and approximately 0.04″, the welding tip 75 with its dual electrodes has a width of between approximately 0.015″ and approximately 0.02″, and the welding access slot 120 has a diameter of between approximately 0.025″ and approximately 0.03″.

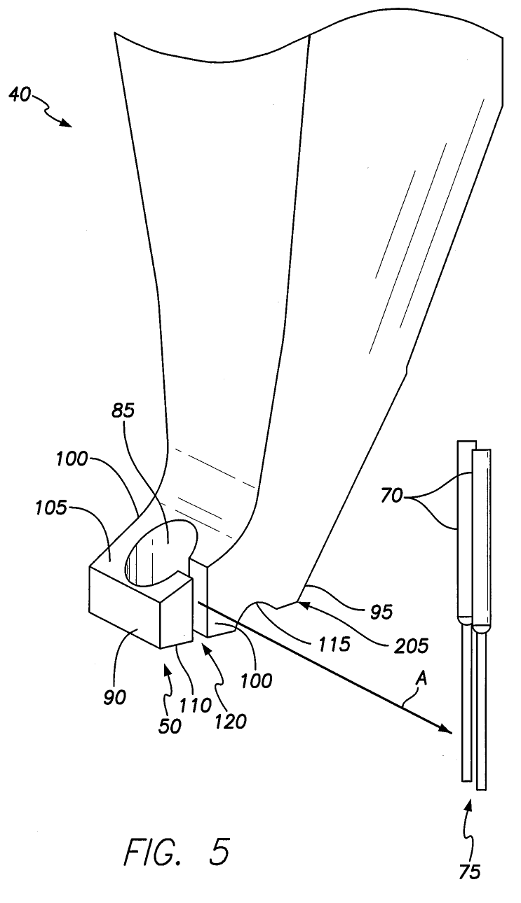

While the embodiment depicted in FIGS. 3 and 4 illustrates the welding access slot 120 extending through the toe 90 to join the welding aperture 85, in other embodiments, the welding access slot may extend through other sides of the bond foot 50 to join the welding aperture. For example, as illustrated in FIGS. 5 and 6, which are the same respective views as FIGS. 3 and 4, except of another embodiment, the welding access slot 120 extends through one of the lateral sides 100 of the bond foot 50 to join the welding aperture 85.

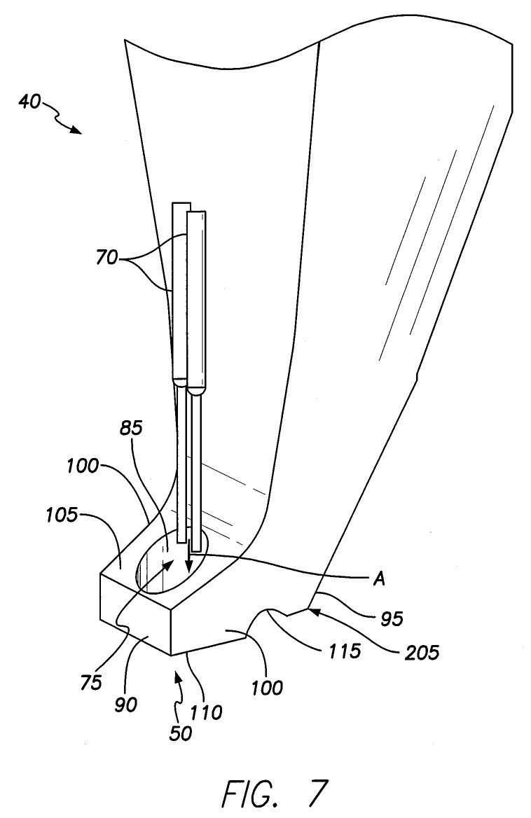

In yet other embodiments, as depicted in FIG. 7, the toe 90 does not include an access slot 120. Instead, the welding header 70 is centered over the welding aperture 85 and configured to move with the welding header 70 as a unit. When the welding header is positioned at a location where a weld is to be made, the welding header 70 displaces vertically as indicated by arrow A in FIG. 7 to enter the welding aperture 85 to create the weld.

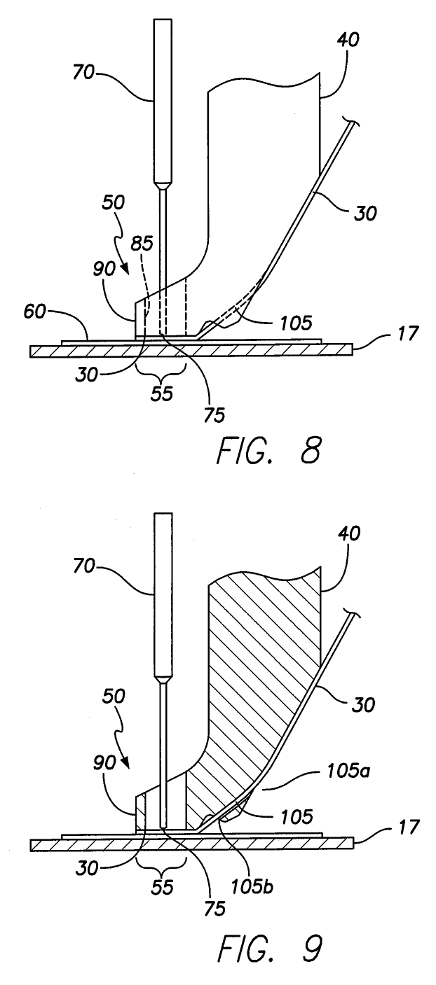

FIGS. 8 and 9 are, respectively, a side elevation view and a side elevation cross sectional view of the embodiment of the bond foot 50 depicted in FIGS. 3 and 4. As can be understood from FIGS. 1, 3, 4, 8 and 9, the ribbon 30, which is a conductive metal ribbon, is supplied on a standard spool 25 and extended down to thread through the threading slot 105 of the bond header 40 to extend along the bottom surface 110 of the bond foot 50. The threading slot 105 is preferably adapted to admit ribbons of various thicknesses, e.g., 1 mil.

As indicated in FIGS. 8 and 9, the bond header 40 descends to the bond surface 60 and forces the ribbon 30 to contact the bond surface of the substrate or component to be bonded, e.g., a printed circuit board or hybrid bond pad supported on the support surface 17. In one embodiment as can be understood from the embodiments depicted in FIGS. 3-6, once a predetermined load is applied to the ribbon 30 sandwiched between the bottom surface 110 (shown in FIGS. 3 and 4) of the bond foot 50 and the bond surface 60, the sandwiched and compressed assembly of the bond foot 50, ribbon 30, bond surface 60 and support surface 17 move as a unit such that the resistance welding tip 75 is caused to enter into the confines of the welding aperture 85 via the access slot 120. Thus, the entry of the welding tip 75 into the aperture 85 is brought about by the bond header 40 and work platform 17 supporting the bond surface 60 and ribbon 30 moving as a unit to the location of the fixed, stationary welding tip 75.

Alternatively for the process depicted in FIGS. 8 and 9, as can be understood from the embodiment depicted in FIG. 7, the bond foot 50 and welding header 70 move as a unit. The bond foot 50 applies a predetermined load to the ribbon 30, which is sandwiched between the bottom surface 110 of the bond foot 50 and the bond surface 60. With the ribbon so sandwiched, the resistance welding tip 75 is caused to enter into the confines of the welding aperture 85 via vertical displacement of the welding tip into the welding aperture, as indicated by arrow A in FIG. 7.

With the bottom surface 110 of the bond foot 50 pressing the ribbon 30 against the bond surface 60 at the bond site 55 and the resistance welding tip 75 having entered the welding aperture 85, the welding tip 75 can be brought into brief contact with the ribbon 30 located within the confines of the welding aperture 85. As a result, current flows as the dual electrodes of the welding tip 75 touches the ribbon 30, thereby causing resistance welding of the ribbon 30 located with the confines of the welding aperture 85 to the bond surface 60 at the bond site 55.

As illustrated in FIG. 10 and as can be understood from FIG. 1, once a first end of the ribbon 30 is resistance welded to a first bond site 55 (indicated by arrow B in FIG. 10) as described above with respect to FIGS. 8 and 9, in the embodiment depicted in FIGS. 3 and 5, the resistance welding tip 75 exits the welding aperture 85 via the access slot 120 and on account of movement as a unit relative to the fixed and stationary welding tip 75 of the bond header 40 and work platform 17 supporting the bond surface 60 and ribbon 30. The bond header 40 then steps (e.g., lifts up and moves horizontally or laterally) to a second bond site 55 (indicated by arrow C in FIG. 10). In displacing from the first bond side to the second bond site, the spool 25 is free to spool out the ribbon 30, resulting in a ribbon segment 118 extending between the first and second bond sites.

As can be understood from FIG. 10, in the embodiment depicted in FIG. 7, the resistance welding tip 75 exits the welding aperture 85 via vertical displacement. The bond header 40 and welding header 70 then steps (e.g., lifts up and moves horizontally or laterally) to a second bond site 55 (indicated by arrow C in FIG. 10). In displacing from the first bond side to the second bond site, the spool 25 is free to spool out the ribbon 30, resulting in a ribbon segment 118 extending between the first and second bond sites.

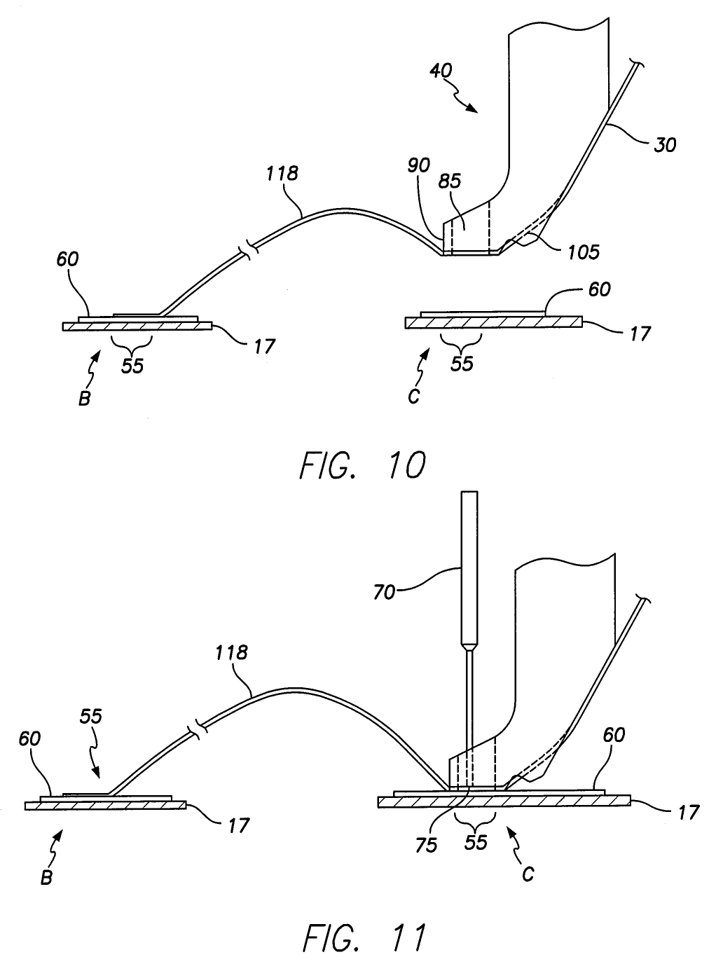

As shown in FIG. 11, once the bond header has stepped to the second bond site 55, the bond header 40 descends to the bond surface 60 and forces the ribbon 30 to contact the bond surface of the substrate or component to be bonded, e.g., a printed circuit board or hybrid bond pad supported on the support surface 17. In one embodiment as can be understood from the embodiments depicted in FIGS. 3-6, once a predetermined load is applied to the ribbon 30 sandwiched between the bottom surface 110 (shown in FIGS. 3 and 4) of the bond foot 50 and the bond surface 60, the sandwiched and compressed assembly of the bond foot 50, ribbon 30, bond surface 60 and support surface 17 move as a unit such that the resistance welding tip 75 is caused to enter into the confines of the welding aperture 85 via the access slot 120. Thus, the entry of the welding tip 75 into the aperture 85 is brought about by the bond header 40 and work platform 17 supporting the bond surface 60 and ribbon 30 moving as a unit to the location of the fixed, stationary welding tip 75.

Alternatively for the process depicted in FIG. 11, as can be understood from the embodiment depicted in FIG. 7, the bond foot 50 and welding header 70 move as a unit. The bond foot 50 applies a predetermined load to the ribbon 30, which is sandwiched between the bottom surface 110 of the bond foot 50 and the bond surface 60. With the ribbon so sandwiched, the resistance welding tip 75 is caused to enter into the confines of the welding aperture 85 via vertical displacement of the welding tip into the welding aperture, as indicated by arrow A in FIG. 7.

With the bottom surface 110 of the bond foot 50 pressing the ribbon 30 against the bond surface 60 at the second bond site 55 and the resistance welding tip 75 having entered the welding aperture 85, the welding tip 75 can be brought into brief contact with the ribbon 30 located within the confines of the welding aperture 85. As a result, current flows as the welding tip 75 touches the ribbon 30, thereby causing resistance welding of the ribbon 30 located with the confines of the welding aperture 85 to the bond surface 60 at the second bond site 55.

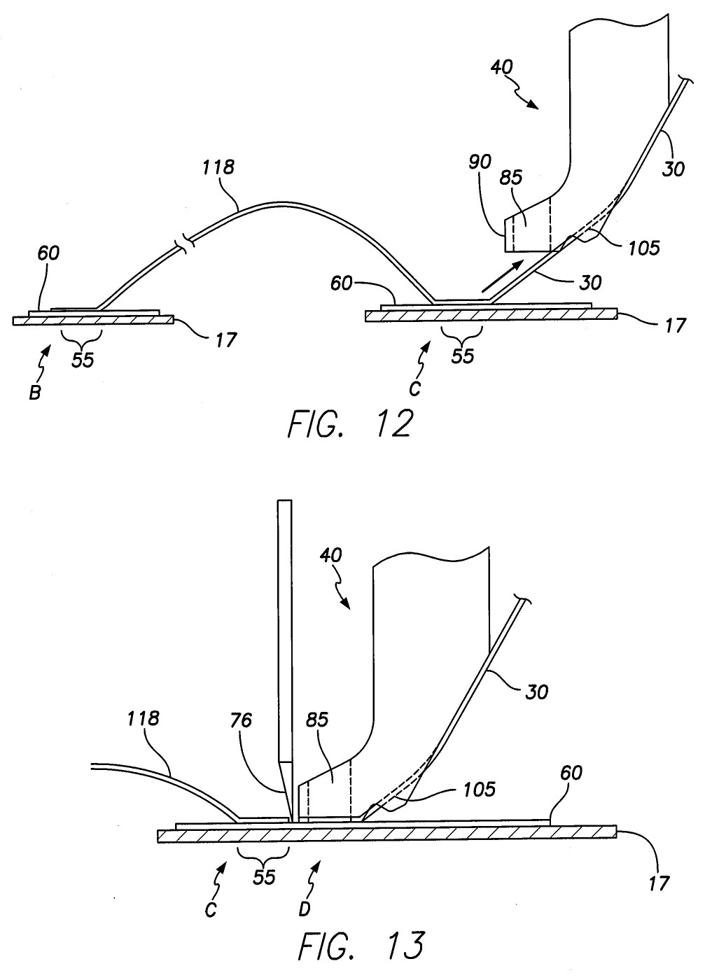

As indicated in FIG. 12 and as can be understood from FIG. 1, once a second end of the ribbon 30 is resistance welded to a second bond site 55 (indicated by arrow C in FIG. 12) as described above with respect to FIG. 11, the resistance welding tip 75 exits the welding aperture 85 via one of the methods described above with respect to FIG. 3, 5 or 7. The bond header 40 then steps (e.g., lifts up and moves horizontally or laterally) to another location such as, for example, yet another bond site or to a location (shown by arrow D in FIG. 13) immediately adjacent the second bond site indicated by arrow C in FIGS. 12 and 13. In making this move, the spool 25 is allowed to rotate, thereby allowing the ribbon 30 to be pulled from the spool 25 down through the threading slot 105 and across the bottom surface 110 of the bond foot 50. The bond foot sandwiches the ribbon against the bond surface 60 at the adjacent site called out by arrow D. With the ribbon so sandwiched, the cutter 76 is vertically displaced to sever the ribbon at the front face of the bond foot. As a result, the ribbon is pre-fed across the bottom surface of the bond foot and the bond header can then move to a new bond location to begin the bonding process over again as set out above with respect to FIGS. 8-13.

In one embodiment, a cutter 76 is not employed to terminate the ribbon 30. For example, in displacing from the second bond side to another location, the spool 25 is prevented from spooling out the ribbon 30, thereby causing the ribbon to break near the heal 95 of the bond foot 50. Specifically, the ribbon clamp 45 clamps down on the ribbon 30 between the spool 25 and the heal 95 to prevent the ribbon 30 from being spooled out further from the spool. The subsequent stepping of the bond header 40 to another location causes the ribbon to fracture at or near the heal 95. As a result, a ribbon segment 118 extends between the first and second bond sites, a first end of the ribbon segment being welded to the first bond site and a second end of the ribbon being welded to the second bond site.

With the ribbon segment 118 welded to the first and second bond sites and the ribbon 30 having been broken off at approximately the heal 95 of the bond foot 50, the spool 25 can feed the ribbon along the bond surface 60 of the bond foot 50 as the bond header 40 moves to yet another location and in anticipation of repeating the welding operation described above with respect to FIGS. 8, 9 and 11.

As can be understood from FIGS. 8-13, depending on the embodiment of the welding system 10, the bond header 40 and/or support surface 17 have several axes or modes of travel, for example, along an x-axis, y-axis, z-axis (vertically), and theta (rotation). Also, depending on the embodiment, the bond header 40 may be moveable relative to a stationary support surface, the support surface moveable relative to a stationary bond header, or the bond header and support surface 17 are both independently moveable relative to each other, but also moveable as a unit together. By these various modes of travel as shown in FIGS. 8-13 and, further, by the bond header 40 moving independently from the support surface 17, or vice versa, the bond header 40 may be positioned at a first bond site 55 (indicated by arrow B) upon the bond surface 60 supported by the support surface 17. Once being appropriately positioned at the first bond site with respect to the x-axis, the y-axis and theta (rotation), the bond header 40 then descends (or the support surface 17 rises) along the z-axis in order to contact the ribbon 30 to the bond surface 60. The ribbon 30 is therefore disposed between the bond foot 50, the bond surface 60 and the support surface 17, and thereby held in place.

With respect to movement of the bond head 40 from a first bond site 55 to a second bond site 55, such bond head motion may be a relative motion only with regard to the work piece containing bond sites, a work table, or the like. In other words, what is generally termed the bond head motion may be one of or a combination of head, table or work piece movements vis-a-vis each other.

As discussed above with respect to FIG. 10, in one embodiment, while the weld between the ribbon 30 and the bond surface 60 at the first bond site 55 is cooling, the bond header 40 may move to the second bond site 55. Such a move between bond sites 55 may be programmed in a memory of the system 10 and caused to be via an operation of a CPU of the system 10. Thus, such a move between bond sites may be through an automated or otherwise predetermined trajectory adapted to spool out from the bond header 40 a desired length of ribbon 30 to form a ribbon segment 118.

The ribbon 30 is fed from the spool through the bond tool ribbon threading slot 105, which holds the ribbon 30 in place during both bonding and displacement of the bond header. The ribbon 30 may freely pass through the ribbon threading slot 105 while the bond header 40 travels between the first and second bond sites 55 (shown at arrows B and C, respectively) or between subsequent bond sites or welds.

As discussed above with respect to FIG. 11, upon contact with a second bond site 55, the ribbon 30 is again disposed between the bond foot 50 and bond surface 60 of the second bond site 55. The welding tip 75 is again located within the welding aperture 85 to form a weld between the ribbon and the bond surface of the second bond site. Thereafter, further ribbon 30 may be spooled out from ribbon spool 25 in order to form a connected second loop from a continuous length of ribbon. Further movement to an immediately adjacent location followed by severing of the ribbon via the cutter 76 results in the ribbon being pre-fed or loaded across the bond foot, as described above with respect to FIGS. 12 and 13. Such operation is advantageous in that it provides positive feeding of the ribbon across the bottom surface of the bond foot and results in the ribbon tending to conform to the surfaces of the bond foot across which the ribbon extends.

Alternatively, as discussed above with respect to FIG. 12, the ribbon 30 may be terminated by clamping the ribbon 30 above the bond head 40 with the clamp 45 or by locking of the ribbon spool. Following the clamping of the ribbon 30, the bond header 40 is moved in a manner leading to breaking of the ribbon 30 in the vicinity of second bond site 55. Additional ribbon 30 can then be played out from the ribbon spool in order to be disposed under the bond foot 50 for re-initiation of the bonding process as described above.

In one embodiment of the invention, “security welds”, i.e., double or other multiple welds, may be effected at each bond site. These security welds serve to increase the contact area for improved current flow, mechanical strength, and reliability. The system 10 makes the weld, moves slightly and welds the ribbon again to the same terminal. The welds may overlap, may combine to form a single uniform weld, or may be completely separate effecting discrete welds.

The system 10 can be a fully automatic, semi-automatic or manual machine. The difference among these applications would lie primarily in the use of programmability and pattern recognition features. In one embodiment, the resistance welding process as described is automated. For example, a device may be presented to the system 10 by manual placement on a work holder or automatically by a conveyor system. The position of the device may be determined by pattern recognition, as is known in the art. Preferably, pattern recognition systems and motion algorithms automatically compensate for variations in positions of the bond sites within the various assemblies in order to provide automation of the bonding process.

In one embodiment, as illustrated in FIG. 1, the optical shape or pattern recognition system includes a camera 200 supported over the bond header 40. The bond foot 40 may be formed of a transparent material to allow the camera 200 to visualize the work area and facilitate the operation of the optical shape or pattern recognition system.

In one embodiment, the bond foot 40 is formed of a non-electrically conductive material. The dual electrodes of the welding tip 75 may each be made of an electrically conductive material, such as, for example, copper. One of the dual electrodes may serve as the positive electrode and the other of the dual electrodes may serve as the negative electrode.

As can be understood from FIG. 9, the ribbon 30 extends through a ribbon guide 105 on the back lower region of the bond foot 40. Depending on the embodiment, the ribbon guide 105 may be part of the unitary construction of the bond foot. Alternatively, the guide 105 may have a multi-piece construction that allows the guide 105 to be swapped out for another guide of a different size or configuration, thereby allowing the guide 105 to be tailored to fit the exact type of ribbon 30 being employed for the welding process. Further, a guide 105 that is separately attached to the bond foot 40 may simplify the routing of the ribbon through the guide 105 during setup of the welding system.

As illustrated in FIGS. 3-7, in some embodiments, the back or heal 95 opposite the toe 90 may a cutting edge 205 defined by a hardened material having a sharp edge. The cutting edge 205 may be a hardened material bonded to the material forming the rest of the electrically non-conductive bond foot 40. In one embodiment, the cutting edge 205 can be replaced separately from the rest of the bond foot.

In one embodiment, the above method may be used to bond a nickel clad copper ribbon 0.002 inches by 0.015 inches (2 mills by 15 mils). In alternate embodiments of the subject method, ribbons of Pt, Ni 205, Ni 270, and Al 6061 may be welded using the above method.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

What is claimed is:

1. A resistance welding system for welding a ribbon to a bond site of a bond surface, the system comprising:
a welding header including a resistance welding tip;
a bond header including a bond foot displaceable relative to the bond surface, the bond foot including a welding aperture;
a ribbon dispenser that feeds the ribbon to the bond foot;
a cutter near the bond foot; and
a support surface configured to support the bond surface;
wherein the bond foot is configured to press the ribbon against the bond site of the bond surface, which is thereby forced against the support surface and, with the ribbon so pressed against the bond site, the system is configured to cause the welding tip to enter the welding aperture to resistance weld the ribbon to the bond site of the bond surface, the system further being configured to then move the bond foot to a location adjacent the bond site and cause the cutter to sever the ribbon at a location between the bond foot and the bond site.

2. The system of claim 1, wherein the bond foot further includes a slot defined in the bond foot and leading from an outer surface of the bond foot to the welding aperture.

3. The system of claim 2, wherein the slot is located in a lateral side of the bond foot.

4. The system of claim 2, wherein the slot is located in a toe side of the bond foot.

5. The system of claim 2, wherein the bond foot is further configured to move in a horizontal plane to cause the stationary resistance welding tip to enter the confines of the welding aperture via the slot.

6. The system of claim 5, wherein, when the bond foot moves horizontally to cause the stationary resistance welding tip to enter the confines of the welding aperture via the slot, the support surface moves as a unit with the bond foot.

7. The system of claim 6, wherein the support surface is both capable of moving as a unit with the bond foot and separately from the bond foot.

8. The system of claim 7, wherein at least one of the bond foot and support surface are capable of movement along an x-axis, y-axis, z-axis and rotation.

9. The system of claim 1, wherein in causing the welding tip to enter the welding aperture to resistance weld the ribbon to the bond site of the bond surface, the welding tip displaces vertically relative to the welding aperture.

10. The system of claim 1, wherein the ribbon dispenser includes a ribbon spool.

11. The system of claim 1, wherein, in causing the cutter to sever the ribbon at a location between the bond foot and the bond site, the cutter displaces vertically adjacent a toe of the bond foot.

12. The system of claim 1, further comprising a shape or image recognition system.

13. The system of claim 12, wherein the bond foot includes a transparent portion, and a camera of the shape or image recognition system is aimed at the transparent portion.

14. A method of connecting electrical components of an implantable medical pulse generator during the course of manufacturing the implantable medical pulse generator, the method comprising:
a) supporting an electrical component on a support surface of a resistance welding system;
b) feeding a ribbon between a bond foot of the resistance welding system and a bond site of a bond surface of the electrical component;
c) causing the bond foot to press the ribbon against the bond site of the bond surface, thereby forcing the electrical component against the support surface;
d) with the bond foot pressed against the ribbon as recited in step c), causing a resistance welding tip to enter a welding aperture of the bond foot;
e) causing the resistance welding tip to resistance weld the ribbon to the bond site of the bond surface within the confines of the aperture;
f) causing the bond foot to displace to a location adjacent the a weld resulting from step e); and
g) using a cutter to sever the ribbon between the weld and the location adjacent the weld.

15. The method of claim 14, wherein the causing of the resistance welding tip to enter the welding aperture includes causing the welding tip to displace vertically into the aperture.

16. The method of claim 14, wherein the causing of the resistance welding tip to enter the welding aperture includes causing the welding tip to displace longitudinally through a slot into the aperture, the slot being defined in the bond foot and leading to the aperture.

17. The method of claim 16, wherein the slot is located in a lateral side of the bond foot.

18. The method of claim 16, wherein the slot is located in a toe side of the bond foot.

19. The method of claim 14, wherein, in causing the cutter to sever the ribbon between weld and the location adjacent the weld, the cutter displaces vertically adjacent a toe of the bond foot.
